(19) United States
(12) Patent Application Publication
(10) Pub. No.: US 2019/0254486 A1
(43) Pub. Date: Aug. 22, 2019

(54) AUTOMATED DOOR SLIDER ASSEMBLY

(71) Applicant: Bath Authority LLC dba Dreamline, Warminster, PA (US)

(72) Inventors: Vadym Mironchuk, Philadelphia, PA (US); Leo Volkov, Wynnewood, PA (US); Michael Minkovich, Richboro, PA (US)

(21) Appl. No.: 15/899,554

(22) Filed: Feb. 20, 2018

(51) Int. Cl. A47K 3/34; E05D 15/06; E05D 15/36

(52) U.S. Cl. CPC A47K 3/34; E05D 15/0686; E05D 15/0691; E05D 15/36; E05Y 2900/114; E05Y 2201/696; E05Y 2201/246; E05Y 2201/708; E05Y 2600/626; E05Y 2201/41; E05Y 2201/422; E05Y 2400/858; E05Y 2600/11

(57) ABSTRACT

An automated door slider assembly is disclosed. The assembly includes a motor unit having a body mounted to a top edge of a stationary support panel and a drive screw bracket installed at an opposite end of the motor unit and mounted to the top edge of the stationary support panel. A longitudinal drive screw having first and second ends is connected to the motor unit at the first end and the drive screw bracket at the second end. A drive screw nut is installed onto the drive screw such that the drive screw nut moves along an axis of the drive screw when the drive screw is rotated by the motor unit during operation. A door panel bracket is attached to a slide panel that moves through the door panel bracket as the drive screw nut moves along the axis of the drive screw when the drive screw is rotated by the motor unit during operation. A drive screw bushing houses the drive screw nut such that the door panel bracket is attached to the drive screw bushing and is moved along the axis of the drive screw with the drive screw nut such that the slide panel is moved between open and closed positions during operation.

### TECHNICAL FIELD

The present invention relates to the field of hardware mechanisms, and more particularly, to an automated door slider assembly to assist in the opening and closing of an interior sliding door in a shower enclosure or in any other suitable environment.

### BACKGROUND

For many years, the most commonly used enclosure for a tub/shower bathing facility has included a pair of sliding glass doors framed in metal. In a typical installation, an outer metal frame circumscribes the entry to the bath and is attached at the sides to the walls of the facility. The installation also includes a header spanning the entrance and a guide rail attached to the tub or shower base. The shower doors are hung at the top from the header and guided at the bottom by the rail so that they can manually slide back and forth in the entryway to allow entry and egress and to create a splash barrier.

There are many disadvantages with the described installation, both functional and aesthetic. The shower doors are typically bulky and heavy, and not easy to manually operate, particularly for users with physical disabilities. Moreover, the metal of the frame and all the glass-to-metal interfaces require special cleaning and maintenance. Apart from these functional constraints, the metal required for the framing, header and rail detracts from a clean and open appearance of the facility.

Various mechanisms eliminating the shower door header have been utilized, including hardware mechanisms with the shower door hingedly or slidably connected to a glass panel, which is in turn mounted to an adjacent wall, for manual operation by the user. Conventional mechanisms are disadvantageous in that they use more hardware material than is desired and hence are heavier or obtrusive in appearance. Further, such conventional mechanisms are not easy to install and require modifications to accommodate shower doors of different sizes.

It would thus be desirable to have an improved hardware mechanism for use in a shower enclosure or in any other suitable environment, among other desirable features as described herein, while avoiding the disadvantages of the known conventional mechanisms.

### SUMMARY

In a first aspect, there is provided herein an automated door slider assembly. The assembly includes a motor unit having a body configured to be mounted to a top edge of a stationary support panel and a drive screw bracket configured to be installed at an opposite end of the motor unit and mounted to the top edge of the stationary support panel. A longitudinal drive screw having a first end and a second end is configured to be connected to the motor unit at the first end and the drive screw bracket at the second end. A drive screw nut is configured to be installed onto the longitudinal drive screw such that the drive screw nut moves along an axis of the longitudinal drive screw when the longitudinal drive screw is rotated by the motor unit during operation. A door panel bracket is configured to be attached to a slide panel at a top edge thereof. The slide panel moves through the door panel bracket as the drive screw nut moves along the axis of the longitudinal drive screw when the longitudinal drive screw is rotated by the motor unit during operation. A drive screw bushing is configured to house the drive screw nut. The door panel bracket is attached to the drive screw bushing and is moved along the axis of the longitudinal drive screw with the drive screw nut such that the slide panel is moved between open and closed positions during operation.

In certain embodiments, the automated door slider assembly further includes a longitudinal cover configured to be attached to the motor unit and the drive screw bracket for concealing at least some of the assembly after installation thereof for safety purposes while in operation.

In certain embodiments, the motor unit in operation is triggered by at least one of a motion sensor built into or onto the motor unit, a smart handle disposed on the slide panel, and a suitable smart device that can be connected to the motor unit either physically or remotely such that the smart device is capable of communication with the motor unit.

In certain embodiments, the smart handle is configured with a wireless connection to the motor unit for triggering the motor unit to open and close the slide panel using touch input.

In certain embodiments, the motor unit is powered by an internal battery pack for recharging by a wireless power transmitter mounted within operating range or is pre-wired directly into a standard AC power source.

In certain embodiments, the motor unit is wired into a main power supply for operation without a power transmitter.

In certain embodiments, the door panel bracket is configured to be detached from the drive screw bushing in the event of a malfunction during operation for preventing the slide panel from being forced into the closed position.

In certain embodiments, the motor unit via a motor disposed therein rotates the longitudinal drive screw that translates rotational force into a linear motion for transfer to the slide panel during operation.

In certain embodiments, the assembly is configured for installation on door panels of variable sizes.

In certain embodiments, the assembly is configured for installation on the stationary support panel in left-hand and right-hand configurations.

In certain embodiments, a plurality of set screws having a soft tip are configured for securing the motor unit and drive screw bracket to the top edge of the stationary support panel.

In certain embodiments, at least some components of the assembly are fabricated from alloys, metals and plastic.

Various advantages of this disclosure will become apparent to those skilled in the art from the following detailed description, when read in light of the accompanying drawings.

### BRIEF DESCRIPTION OF THE DRAWINGS

FIG. 1 is a perspective view of an exemplary shower enclosure incorporating an automated door slider assembly in accordance with an embodiment of the present disclosure.

FIG. 2 is a front elevation view of the exemplary shower enclosure incorporating the automated door slider assembly of FIG. 1.

FIG. 3 is a top plan view of the automated door slider assembly installed in the exemplary shower enclosure of FIG. 1.

FIG. 4 is an enlarged, exploded perspective view of the automated door slider assembly of FIG. 3.

FIG. 5 is an enlarged, cross-sectional view along the line 5-5 in FIG. 3 showing the automated door slider assembly installed in the exemplary shower enclosure in accordance with an embodiment of the present disclosure.

FIG. 6 is a perspective view of an exemplary shower enclosure incorporating the automated door slider assembly installed in a left hand configuration with the slide panel shown in an open position in accordance with an embodiment of the present disclosure.

FIG. 7 is a perspective view of an exemplary shower enclosure incorporating the automated door slider assembly installed in a right hand configuration with the slide panel shown in a closed position in accordance with an embodiment of the present disclosure.

### DETAILED DESCRIPTION

This disclosure is not limited to the particular apparatus, systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All sizes recited in this document are by way of example only, and the present disclosure is not limited to the automated door slider assembly having the specific sizes or dimensions recited herein. As used herein, the term “comprising” means “including, but not limited to.”

In consideration of the figures, it is to be understood for purposes of clarity certain details of construction and/or operation are not provided in view of such details being conventional and well within the skill of the art upon disclosure of the document described herein. In the figures, like numerals indicate like elements throughout.

The present disclosure pertains to an automated door slider assembly for use in a shower enclosure or in any other suitable environment. The automated door slider assembly is easy to install without a need for complex tools and any previous modifications. The automated door slider assembly can be easily installed onto an existing door panel in both left-hand and right-hand configurations. The components of the automated door slider assembly can be easily adjusted to accommodate door panels of different sizes. Moreover, the automated door slider assembly utilizes a motor unit with a motor disposed therein powered by an internal battery pack that rotates a drive screw that in turn translates the rotational force into a linear motion that is transferred to the movable door panel. The drive screw mechanism is reliable, quiet in operation, and easy to maintain; it provides an efficient, smooth and noise-free transfer of motion from the motor unit to the door panel. Further, the automated door slider assembly does not require any electrical work prior to installation. The automated door slider assembly can be operated via a built-in motion sensor, a remote smart handle disposed on the slide panel, or any other suitable device with a physical or wireless connection to the motor unit, among other desirable features as described herein.

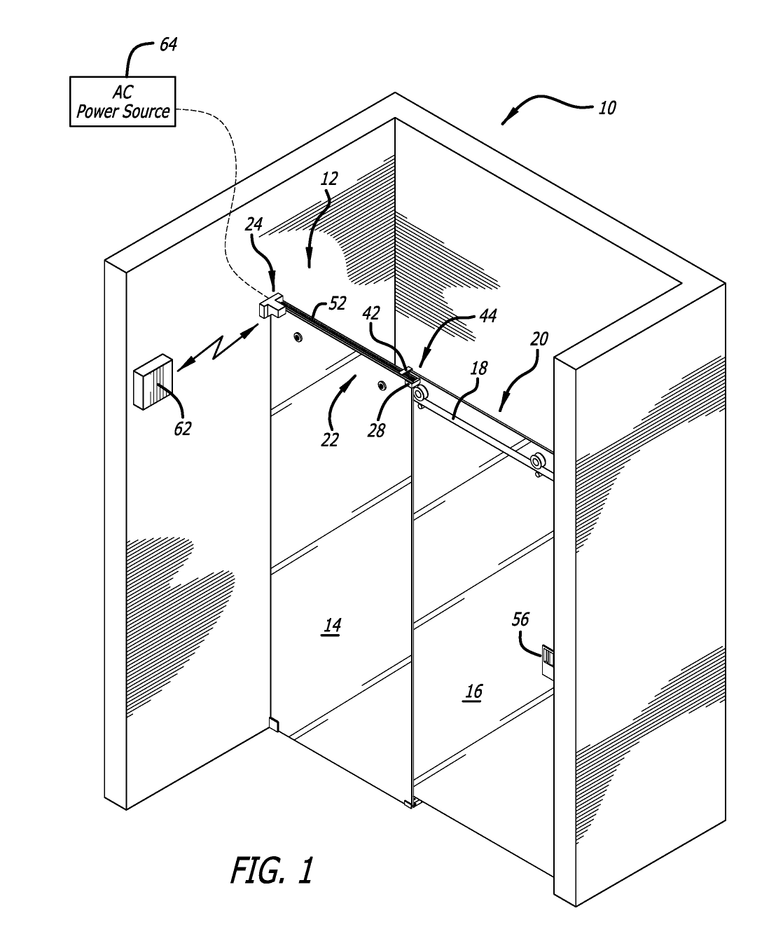

Referring now to FIG. 1 is a perspective view of an exemplary shower enclosure 10 incorporating an automated door slider assembly 12 in accordance with an embodiment of the present disclosure. The shower enclosure 10 includes a stationary glass panel 14 and a moveable slide door 16. The slide door 16 is slidably connected to the stationary glass panel 14 via a guide rail 18 disposed at a top 20 of the shower enclosure 10. The automated door slider assembly 12 is disposed at a top edge 22 of the stationary glass panel 14. Such a configuration maintains a clean aesthetic appearance for the shower enclosure 10. It should be understood that the automated door slider assembly 12 is not limited to the exemplary shower enclosure 10 illustrated in FIG. 1 as the automated door slider assembly 12 can be used in other suitable environments as well. The illustrated shower enclosure 10 in a typical alcove layout in FIG. 1 is for illustration only as the automated door slider assembly 12 can be utilized on shower door panels of different sizes in various shower enclosure configurations. It should be understood that the stationary glass panel 14 and slide door 16 are not limited to glass and can be fabricated of other suitable materials for use with the automated door slider assembly 12 of the present disclosure.

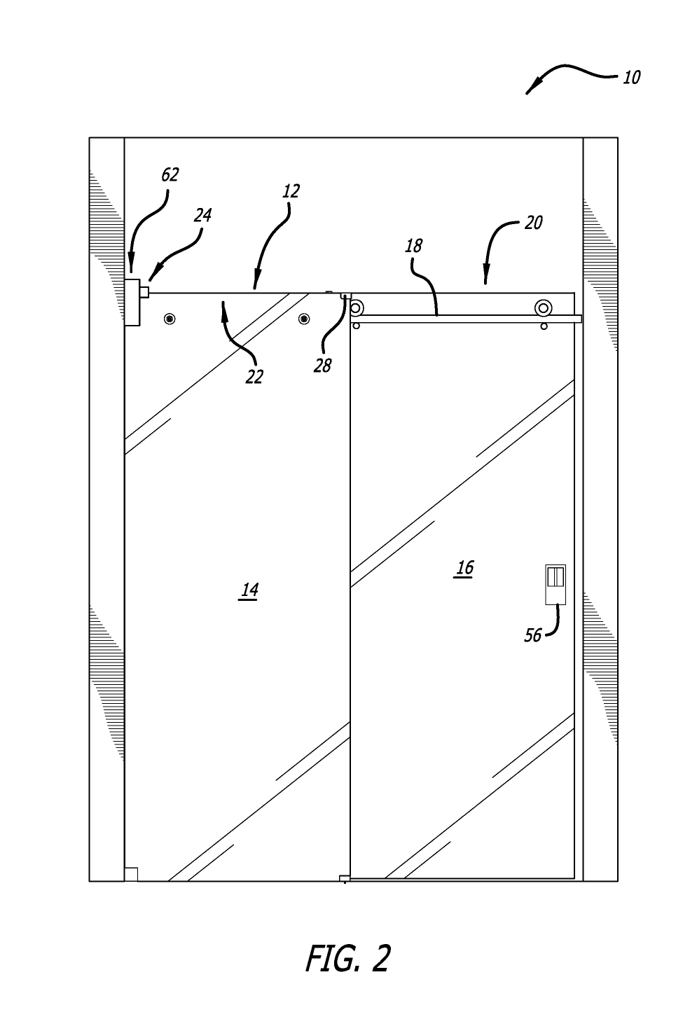

FIG. 2 is a front elevation view of the exemplary shower enclosure 10 incorporating the automated door slider assembly 12 of FIG. 1 of the present disclosure.

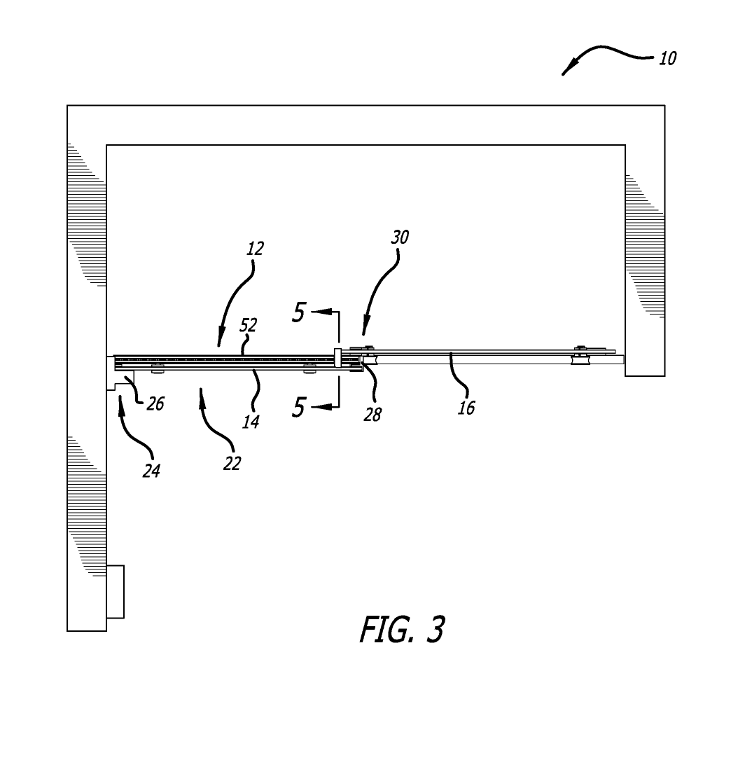

Referring to FIGS. 3-7, the automated door slider assembly 12 will be described in more detail. The automated door slider assembly 12 generally includes a motor unit 24 having a motor 25 disposed therein and a body 26 configured to be mounted to a top edge 22 of a stationary support panel 14 and a drive screw bracket 28 configured to be installed at an opposite end 30 of the motor unit 24 and mounted to the top edge 22 of the stationary support panel 14. A longitudinal drive screw 32 having a first end 34 and a second end 36 is configured to be connected to the motor unit 24 at the first end 34 and the drive screw bracket 28 at the second end 36. A plurality of set screws 37 with a soft tip can be used to secure the motor unit 24 and drive screw bracket 28 to the top edge 22 of the stationary support panel 14. Both the motor unit 24 and the drive screw bracket 28 are configured to have a U-shaped channel to fit around the top edge 22 of the stationary support panel 14. The plurality of set screws 37 are tightened against the stationary support panel 14 that in turn clamps the stationary support panel 14 within the U-shaped channel of both the motor unit 24 and the drive screw bracket 28. A drive screw nut 38 is configured to be installed onto the longitudinal drive screw 32 such that the drive screw nut 38 moves along an axis 40 of the longitudinal drive screw 32 when the longitudinal drive screw 32 is rotated by the motor unit 24 via the motor 25 during operation.

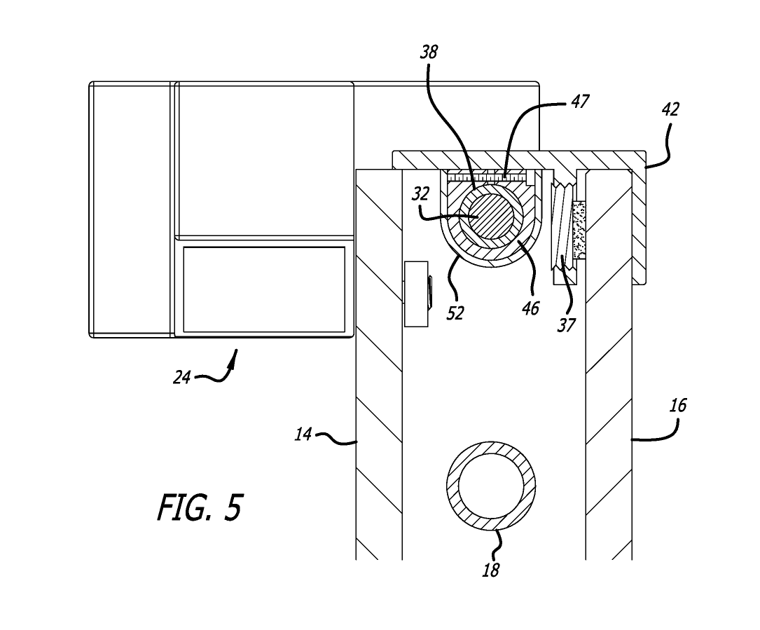

A door panel bracket 42 is configured to be attached to a slide panel 16 at a top edge 44 thereof. The slide panel 16 moves through the door panel bracket 42 as the drive screw nut 38 moves along the axis 40 of the longitudinal drive screw 32 when the longitudinal drive screw 32 is rotated by the motor unit 24 via the motor 25 during operation. The rotation of the longitudinal drive screw 32 by the motor unit 24 via the motor 25 translates rotational force into a linear motion that is transferred to the slide panel 16 during operation. A drive screw bushing 46 is configured to house the drive screw nut 38. A fastener 47 such as a machine screw and the like can be used with the drive screw bushing 46 to tighten the drive screw bushing 46 to the drive screw nut 38 as shown in FIG. 5. The door panel bracket 42 can be attached to the drive screw bushing 46 and the slide panel 16 via any suitable attachment mechanism, such as set screws 37 and the like. The door panel bracket 42 is moved along the axis 40 of the longitudinal drive screw 32 with the drive screw nut 38 such that the slide panel 16 is moved between open and closed positions 48 and 50 during operation.

In accordance with the present disclosure, the automated door slider assembly 12 further includes a longitudinal cover 52 configured to be attached to the motor unit 24 and the drive screw bracket 28 for concealing at least some of the assembly 12 after installation thereof for safety purposes while in operation. The longitudinal cover 52 is configured to be attached to the automated door slider assembly 12 by snap fit or any suitable attachment mechanism. The longitudinal cover 52 can be decorative or non-decorative in appearance and can be trimmed to the required size.

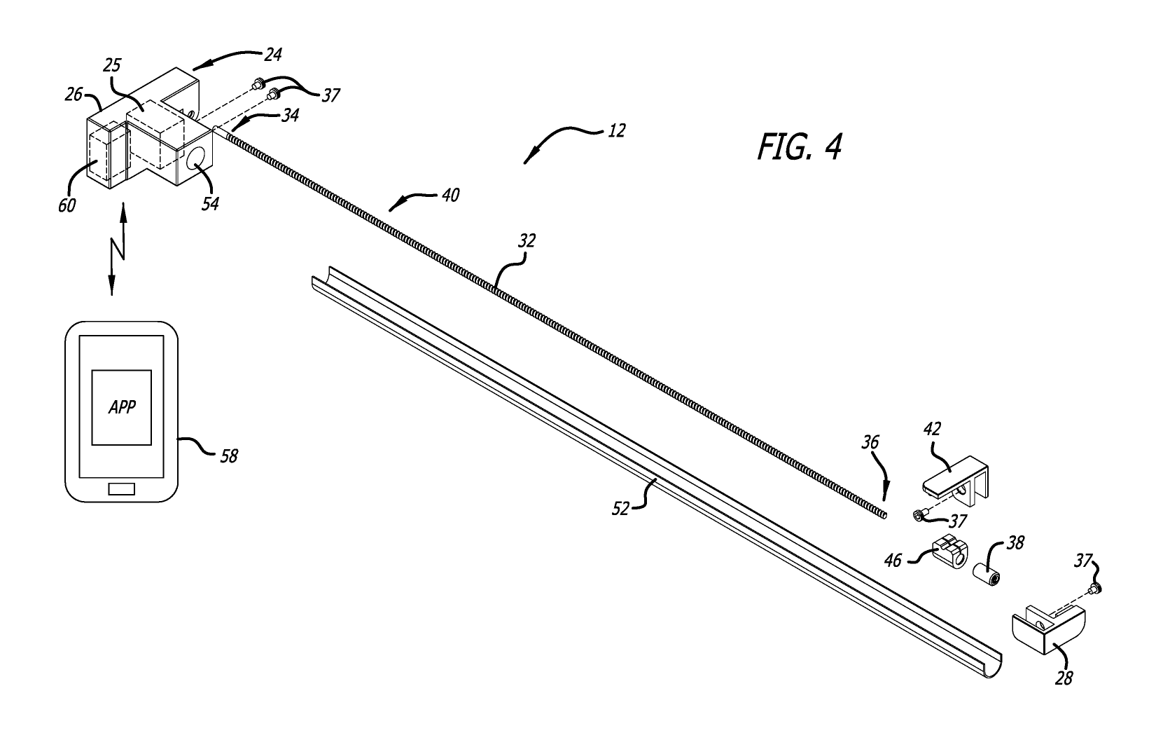

In some embodiments, the motor unit 24 in operation is triggered by at least one of a motion sensor 54 built into or onto the motor unit 24 (see FIG. 4), a smart handle 56 disposed on the slide panel 16 (see FIGS. 1-2 and 6-7), and any suitable smart device 58 (e.g., smart phone, tablet and the like) that can be connected to the motor unit 24 either physically or remotely such that the smart device 58 is capable of communication with the motor unit 24 (see FIG. 4). For example, the smart handle 56 can be configured with a wireless connection to the motor unit 24 in which the motor unit 24 is triggered to open and close the slide panel 16 using touch input thereon the smart handle 56 by a user.

It should be understood that the automated door slider assembly 12 can use different motor units of different power rating and design in accordance with the present disclosure.

In the illustrated embodiments, the motor unit 24 is powered by an internal battery pack 60 (FIG. 4) that is recharged by a wireless power transmitter 62 mounted within operating range and away from the moist environment of the shower enclosure 10 or pre-wired directly into a standard AC power source 64 as shown in FIG. 1.

In other embodiments, the motor unit 24 is wired into a main power supply 64 such that the motor unit 24 is capable of operating without a power transmitter 62.

In accordance with the present disclosure, the door panel bracket 42 is configured to be detached from the drive screw bushing 46 in the event of a malfunction during operation thereby preventing the slide panel 16 from being forced into the closed position 50.

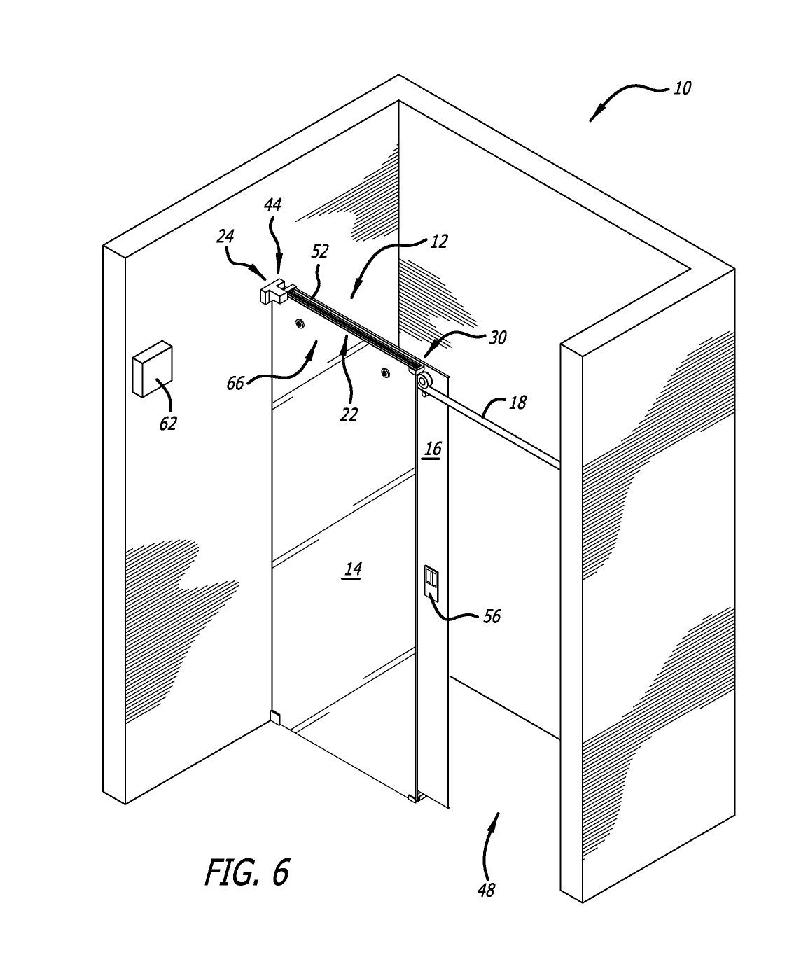

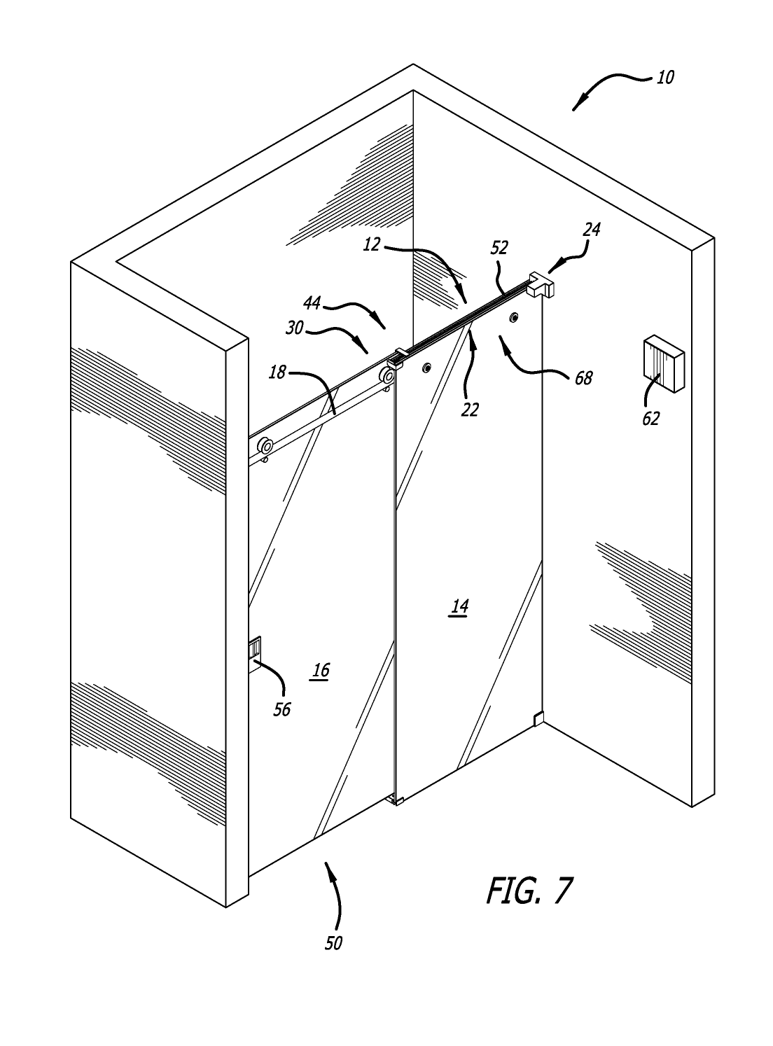

FIG. 6 is a perspective view of an exemplary shower enclosure 10 incorporating the automated door slider assembly 12 installed in a left-hand configuration 66 as in FIG. 1 with the slide panel 16 shown in the open position 48. FIG. 7 is a perspective view of an exemplary shower enclosure 10 incorporating the automated door slider assembly 12 installed in a right-hand configuration 68 with the slide panel 16 shown in the closed position 50. In the illustrated embodiments, the automated door slider assembly 12 is configured to be installed on existing shower door panels of variable sizes in both left-hand and right-hand configurations 66 and 68 of the shower enclosure 10.

It should be understood that the various hardware components of the automated door slider assembly 12 described herein can be fabricated of any suitable sturdy material, such as stainless steel, metal alloys, plastic and the like. Similarly, it should be understood that the various hardware components of the automated door slider assembly 12 can be fabricated in different finishes, such as polished, brushed, powder coated and the like, and different colors.

It should be further understood that the automated door slider assembly 12 and various components thereof can be fabricated in different sizes and shapes and are sized to scale the particular shower enclosure selected to be installed in the bathroom space or the particular structure in any other suitable environment. Some of the various components of the automated door slider assembly 12 can be fabricated by any suitable manufacturing process, such as by casting, extrusion and the like.

These and other advantages of the present disclosure will be apparent to those skilled in the art. Accordingly, it will be recognized by those skilled in the art that changes or modifications may be made to the above described embodiments without departing from the broad inventive concepts of the present disclosure. It should therefore be understood that the present disclosure is not limited to the particular embodiments described herein, but is intended to include all changes and modifications that are within the scope and spirit of the disclosure as encompassed by the following claims.

What is claimed is:

1. An automated door slider assembly, comprising:
a motor unit having a body configured to be mounted to a top edge of a stationary support panel;
a drive screw bracket configured to be installed at an opposite end of the motor unit and mounted to the top edge of the stationary support panel;
a longitudinal drive screw having a first end and a second end and configured to be connected to the motor unit at the first end and the drive screw bracket at the second end;
a drive screw nut configured to be installed onto the longitudinal drive screw, wherein the drive screw nut moves along an axis of the longitudinal drive screw when the longitudinal drive screw is rotated by the motor unit during operation;
a door panel bracket configured to be attached to a slide panel at a top edge thereof, wherein the slide panel moves through the door panel bracket as the drive screw nut moves along the axis of the longitudinal drive screw when the longitudinal drive screw is rotated by the motor unit during operation; and
a drive screw bushing configured to house the drive screw nut, wherein the door panel bracket is attached to the drive screw bushing and is moved along the axis of the longitudinal drive screw with the drive screw nut for moving the slide panel between open and closed positions during operation.

2. The automated door slider assembly of claim 1 further comprising:
a longitudinal cover configured to be attached to the motor unit and the drive screw bracket for concealing at least some of the assembly after installation thereof for safety purposes while in operation.

3. The automated door slider assembly of claim 1, wherein the motor unit in operation is triggered by at least one of a motion sensor built into the motor unit, a smart handle disposed on the slide panel, and a suitable smart device that can be connected to the motor unit either physically or remotely such that the smart device is capable of communication with the motor unit.

4. The automated door slider assembly of claim 3, wherein the smart handle is configured with a wireless connection to the motor unit for triggering the motor unit to open and close the slide panel using touch input.

5. The automated door slider assembly of claim 1, wherein the motor unit is configured to be powered by an internal battery pack for recharging by a wireless power transmitter mounted within operating range or is configured for pre-wiring directly into a standard AC power source.

6. The automated door slider assembly of claim 1, wherein the motor unit is configured for wiring into a main power supply for operation without a power transmitter.

7. The automated door slider assembly of claim 1, wherein the door panel bracket is configured to be detached from the drive screw bushing in the event of a malfunction during operation for preventing the slide panel from being forced into the closed position.

8. The automated door slider assembly of claim 1, wherein the motor unit via a motor disposed therein rotates the longitudinal drive screw that translates rotational force into a linear motion for transfer to the slide panel during operation.

9. The automated door slider assembly of claim 1, wherein the assembly is configured for installation on door panels of variable sizes.

10. The automated door slider assembly of claim 1, wherein the assembly is configured for installation on the stationary support panel in left-hand and right-hand configurations.

11. The automated door slider assembly of claim 1, wherein a plurality of set screws having a soft tip are configured for securing the motor unit and drive screw bracket to the top edge of the stationary support panel.

12. The automated door slider assembly of claim 1, wherein at least some components of the assembly are fabricated from alloys, metals and plastic.
